(19) United States
(12) Patent Application Publication
(10) Pub. No.: US 2011/0242067 A1
(43) Pub. Date: Oct. 6, 2011

(54) MULTII-SCAN ANALOG SUB-FIELDS FOR SAMPLE AND HOLD DISPLAYS

(76) Inventors: Sébastien Weitbruch, Niedereschac/Keppel (DE); Carlos Corres, Deutenbergeing (DE); Cedric Thebault, Chantaple (FR)

(21) Appl. No.: 12/998,879

(22) PCT Filed: Dec. 11, 2009
(86) PCT No.: PCT/EP2009/066954

§ 371 Date: Jun. 13, 2011

(51) Int. Cl. G09G 5/00

(52) U.S. Cl. 345/204

(57) ABSTRACT

An addressing method for sample and hold displays suitable for multi-scan applications (supporting several frame rates) shall be provided. Thus, there is disclosed a method for displaying a picture on a display screen including the steps of providing an input signal including a sequence of plural frames, each corresponding to a single picture, temporally dividing each frame having a frame duration into sub-fields and controlling a display element of the display screen on the basis of the sub-fields. The number and/or duration of sub-fields of each frame is automatically adapted to the frame duration of the frame. Furthermore, the amplitude of a sub-field controlling signal corresponding to the last subfield of each frame may be automatically adapted to the frame duration of the frame. Such display methods provide for a high grayscale quality and linearity even if the frame rate is not stable nor well-defined.

The present invention relates to a method for displaying a picture on a display screen including the steps of providing an input signal including a sequence of plural frames, each corresponding to a single picture, temporally dividing each frame having a frame duration into sub-fields and controlling a display element of the display screen on the basis of said subfields. Furthermore, the present invention relates to corresponding display devices.

### BACKGROUND

Traditional sample and hold display addressing methods used for OLED or LCD, etc. are very suitable for multi-scan applications (supporting several frame rates). In other words they can support several frame rates or unstable frame rates without any problem.

However, the newly addressing concept (analog sub-fields) proposed in the documents EP 174 3315, EP 1914709 and EP 196 4092 that provides enhanced grayscale quality and better motion rendition cannot support this feature (multi-scan) at present. As to the sub-field addressing concept it is expressively referred to the above-mentioned documents. This concept is specifically proposed for display devices of the OLED or AMOLED type.

The document EP 0 847 037 A1 discloses a video display monitor, such as a plasma monitor, where the stable driving is assured although vertical synchronizing frequency of the input video signal changes. A vertical synchronizing measurement unit measures the vertical synchronizing frequency of the video signal, and a sub-field number adjustment unit adjusts the number of sub-fields in accordance with a measured vertical synchronizing frequency. Furthermore, the length of the sub-fields may be adjusted.

### INVENTION

It is the object of the present invention to further develop the sub-field addressing concept in order to support a full flexible frame rate application while maintaining a high grayscale quality and linearity.

The above-mentioned object is solved according to claim 1 by a method for displaying a picture on a multi-scan hold type display screen including the steps of providing an input signal including a sequence of plural frames, each corresponding to a single picture, temporally dividing each frame having a frame duration into analog sub-fields, providing a set of reference signals for specifying the analog signal amplitudes of sub-field controlling signals, each corresponding to one of said analog sub-fields, controlling a display element of the display screen on the basis of said sub-field controlling signals wherein the amplitude of a sub-field controlling signal corresponding to the last subfield of each frame is automatically adapted to the frame duration of the frame.

Similarly, according to claim 4 there is provided a multiscan hold type display device for displaying a picture including a display screen having a plurality of display elements, input means for providing an input signal including a sequence of plural frames, each corresponding to a single picture, encoding means for temporally dividing each frame having a frame duration into analog sub-fields, controlling means for providing a set of reference signals for specifying the analog signal amplitudes of sub-field controlling signals, each corresponding to one of said analog sub-fields, and for controlling a display element of the display screen on the basis of said sub-field controlling signals, and further including adaption means for automatically adapting the amplitude of a sub-field controlling signal corresponding to the last sub-field of each frame to the frame duration of the frame.

This concept of adapting the amplitude of the last sub-field (controlling signal) can be applied to display devices alone or in connection with the adaption of the number of sub-fields of each frame as mentioned above. Furthermore, the above described concept for supporting a multiscan feature is preferably applicable to OLED or AMOLED displays. Optionally the amplitude of a reference signal of the last sub-field is adapted to the frame duration automatically.

### DRAWINGS

The present invention will be described in more detail along with following figures, showing in:

FIG. 1 a block diagram of the electronic of an AMOLED;

FIG. 2 an example of an OLED display structure;

FIG. 3 the principle of an AMOLED column driver;

FIG. 4 a comparison of CRT versus AMOLED;

FIG. 5 a comparison of low gray level versus high gray level;

FIG. 6 an AMOLED reaction regarding different input frame frequencies;

FIG. 7 an AMOLED greyscale rendition with analog sub-fields;

FIG. 8 two alternative solutions for grayscale rendition with analog sub-fields;

FIG. 9 an example of the sub-field structure of a frame,

FIG. 10 a diagram showing the obtained energy versus the awaited energy with 60 Hz optimized coding at 60 Hz;

FIG. 11 the displayed error with 60 Hz optimized coding at 60 Hz;

FIG. 12 the obtained energy relative to the awaited energy at 60 Hz;

FIG. 13 an analog sub-field reaction regarding different input frame frequencies;

FIG. 14 the obtained energy versus awaited energy with 60 Hz optimized coding at 66.7 Hz;

FIG. 15 the displayed error with 60 Hz optimized coding at 66.7 Hz;

FIG. 16 the obtained energy relative to the awaited energy at 66.7 Hz;

FIG. 17 the variation between 60 Hz and 66.7 Hz,

FIG. 18 an implementation of analog sub-fields with increased bit depth;

FIG. 19 a sub-field length optimization regarding different input frame frequencies,

FIG. 20 a sub-field length and a sub-field number optimization for different input frame frequencies and

FIG. 21 an implementation of analog sub-fields with multi-scan option.

### EXEMPLARY EMBODIMENTS

### 1.0LED Driving and Grayscale Rendition

### 1.1. OLED Display Structure

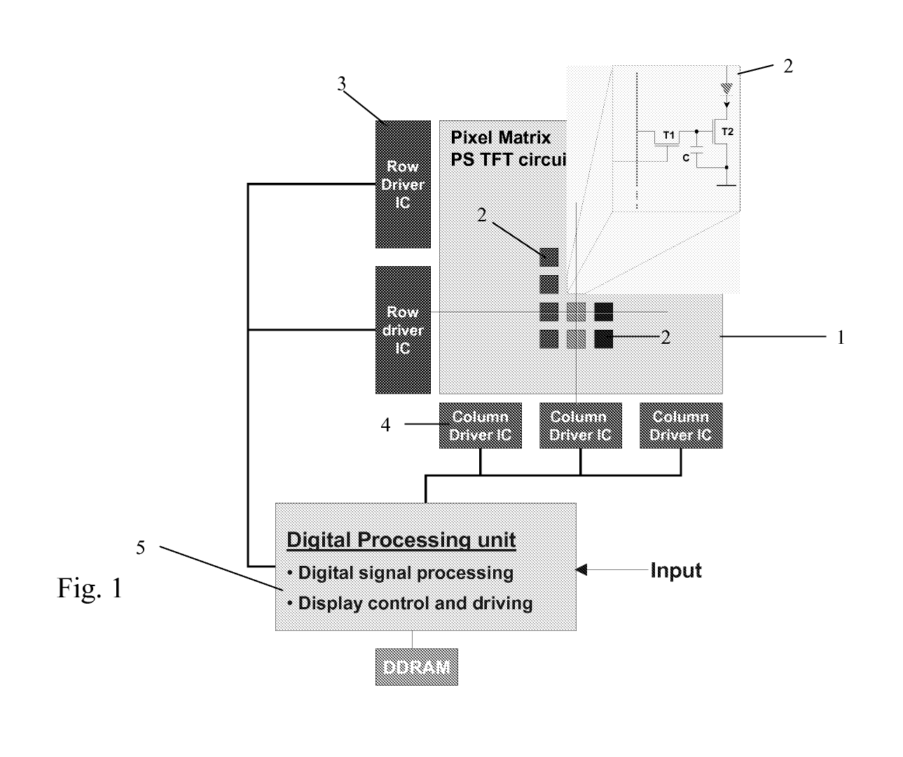

The following embodiment is related to an active OLED matrix (AMOLED) where each cell of the display is controlled via an association of several TFTs. The general structure of such an electronic is illustrated in FIG. 1.

Generally an AMOLED display includes following components:
An active matrix 1 containing, for each cell 2, an association of several TFTs T1 and T2 with a capacitor C and connected to the OLED material: the capacitor C acts as a memory component that stores the value of the cell during a certain part of the frame. The TFTs T1 and T2 are acting as switch enabling the selection of the cell, the storage of the capacitance and the lighting of the cell 2. In that case, the value stored in the capacitance determines the luminance produced by the cell.
Row (gate) drivers 3 that select line by line the cells 2 of the screen in order to refresh their content,
Column (source) drivers 4 that deliver the value (content) to be stored in each cell 2 of the current selected line. This component receives really the video information for each cell.
A digital processing unit 5 that applies required video and signal-processing steps and that delivers the required signals to the row and column drivers 3, 4.

Actually, there are two ways for driving OLED cells:
Current driven concept: in that case the digital information sent by the driving unit will be converted by the column drivers 4 in current amplitude that will be injected into the cell structure.
Voltage driven concept: in that case the digital information sent by the driving unit will be converted by the column drivers 4 in voltage amplitude that will be injected into the cell structure.

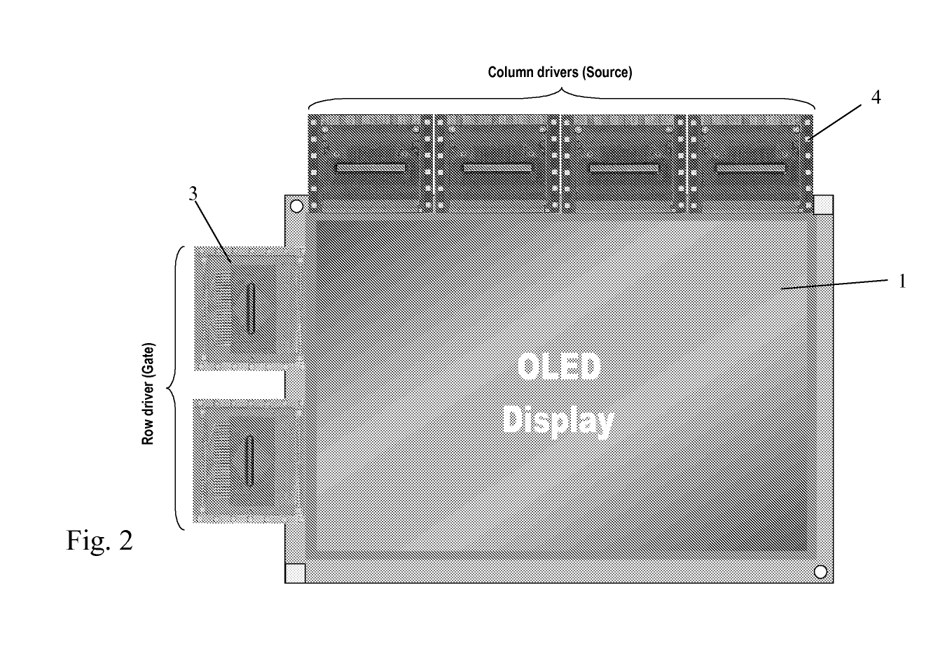

It should be noticed that an OLED is current driven so that each voltage based driving system is based on a voltage to current converter to achieve appropriate cell lighting. FIG. 2 illustrates a possible AMOLED display structure. As already said the row drivers 3 have a quite simple function since they only have to apply a selection line by line. Each row driver 3 is more or less a shift register.

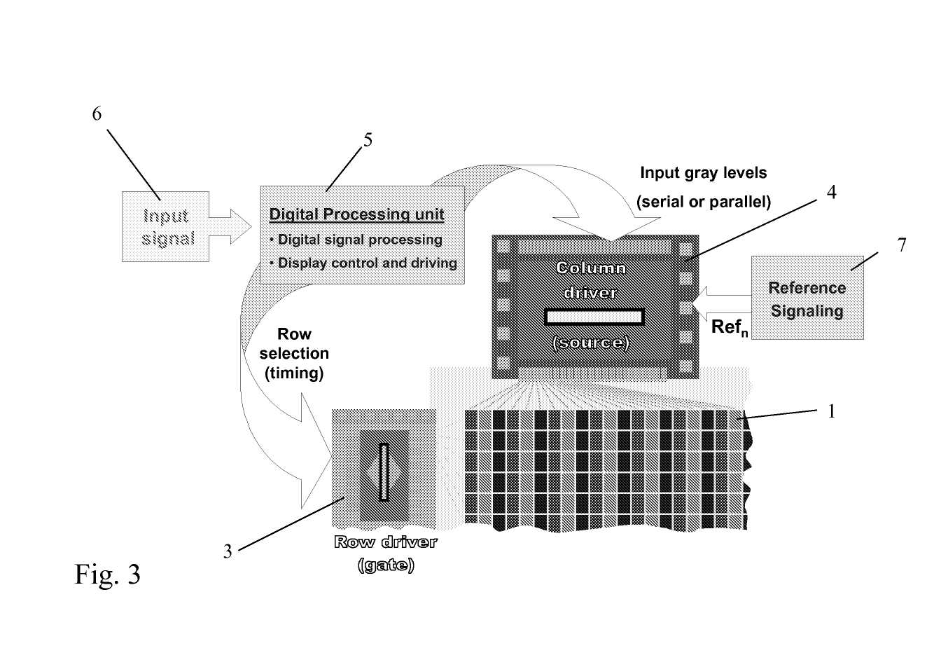

On the other hand, the column drivers 4 represent the real active part and can be considered as high-level digital to analog converters as illustrated in FIG. 3.

Specifically FIG. 3 illustrates the functioning of basic OLED column drivers 4. The input signal is forwarded to the Digital Processing Unit 5 (DPU) that delivers, after internal processing, a timing signal for row selection to the row driver 3 synchronized with the data sent to the column drivers 4. Depending on the used driver, the data are either parallel or serial. Additionally, the column driver 4 disposes of a reference signalling 7 delivered by a separate component called reference signaling in this document. This component delivers a set of reference voltages in case of voltage driven circuitry or a set of reference currents in case of current driven circuitry. The highest reference being used for the white and the lowest for the smallest gray level.

In order to illustrate this concept, the example of a voltage driven circuitry is taken in the rest of this document. The driver taken as example will use 8 reference voltages named V₀ to V₇ and the video levels are built as explained in Table 1:

TABLE 1
Gray level table from voltage driver

| Video level | Grayscale voltage level |
|---|---|
| 0 | V7 |
| 1 | V7 + (V6 − V7) × 9/1175 |
| 2 | V7 + (V6 − V7) × 32/1175 |
| 3 | V7 + (V6 − V7) × 76/1175 |
| 4 | V7 + (V6 − V7) × 141/1175 |
| 5 | V7 + (V6 − V7) × 224/1175 |
| 6 | V7 + (V6 − V7) × 321/1175 |
| 7 | V7 + (V6 − V7) × 425/1175 |
| 8 | V7 + (V6 − V7) × 529/1175 |
| 9 | V7 + (V6 − V7) × 630/1175 |
| 10 | V7 + (V6 − V7) × 727/1175 |
| 11 | V7 + (V6 − V7) × 820/1175 |
| 12 | V7 + (V6 − V7) × 910/1175 |
| 13 | V7 + (V6 − V7) × 998/1175 |
| 14 | V7 + (V6 − V7) × 1086/1175 |
| 15 | V6 |
| 16 | V6 + (V5 − V6) × 89/1097 |
| 17 | V6 + (V5 − V6) × 173/1097 |
| 18 | V6 + (V5 − V6) × 250/1097 |
| 19 | V6 + (V5 − V6) × 320/1097 |
| 20 | V6 + (V5 − V6) × 386/1097 |
| 21 | V6 + (V5 − V6) × 451/1097 |
| 22 | V6 + (V5 − V6) × 517/1097 |
| . . . | . . . |
| 250 | V1 + (V0 − V1) × 2278/3029 |
| 251 | V1 + (V0 − V1) × 2411/3029 |
| 252 | V1 + (V0 − V1) × 2549/3029 |
| 253 | V1 + (V0 − V1) × 2694/3029 |
| 254 | V1 + (V0 − V1) × 2851/3029 |
| 255 | V0 |

The greyscale voltage levels represent output voltages for various input video levels. Later on in connection with the analog sub-field concept these output voltages are called “sub-field controlling signals”. Table 2 shows possible voltage references for reference signaling 7.

TABLE 2
Example of voltage references

| Reference | Voltage |
|---|---|
| Vₙ | (V) |
| V0 | 3 |
| V1 | 2.6 |
| V2 | 2.2 |
| V3 | 1.4 |
| V4 | 0.6 |
| V5 | 0.3 |
| V6 | 0.16 |
| V7 | 0 |

### 1.2. AMOLED Standard Grayscale Rendition

Independently if the chosen AMOLED concept is current-driven or voltage-driven, the grayscale level is defined by storing during one frame an analog value in a capacitor located at the current pixel location. This value is kept by the pixel up to the next refresh coming with the next frame. In that case, the video value is rendered in a fully analog manner and stays stable during the whole frame.

This concept is different from of a CRT that works with an impulse.

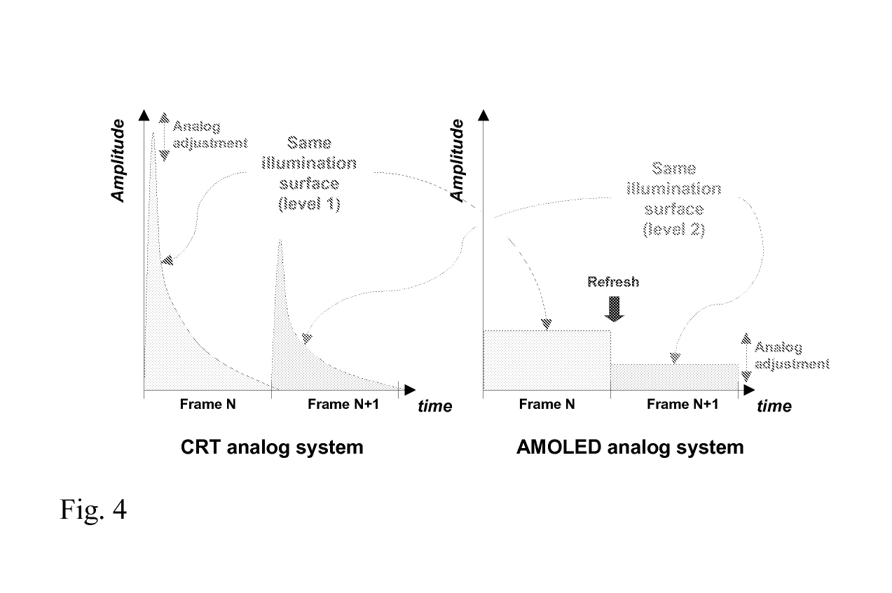

FIG. 4 shows that in the case of CRT, the selected pixel will receive a pulse coming from the beam and generating on the phosphor screen a lighting peak that decreases rapidly depending on the phosphor persistence. A new peak will be produced exactly one frame later (e.g. 20 ms later for 50 Hz, 16.67 ms later for 60 Hz and so on).

In case of an AMOLED, the luminance of the current pixel is stable during the whole frame period. The value of the pixel will be updated only at the beginning of each frame.

In the previous example, the surface of the illumination curves for level 1 and level 2 are equal for CRT and AMOLED if the same power management system is used. All amplitude being controlled in an analog way.

### 1.3 Basic AMOLED and Low Level Rendition

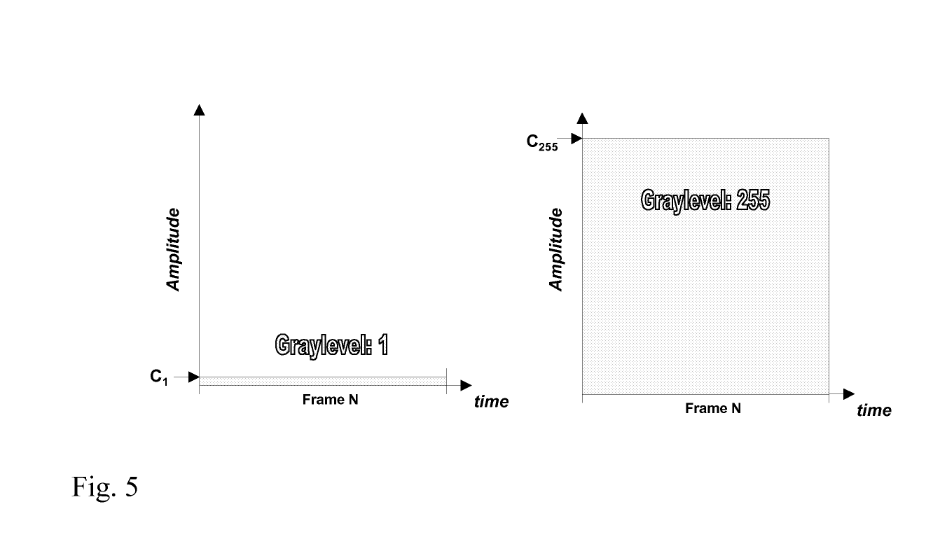

FIG. 5 shows a comparison of the displaying of two extreme gray levels on a 8-bit AMOLED display. There is a big difference between the lowest gray level produced by using the control signal C₁ and the highest gray level (white) produced by using the control signal C₂₅₅.

It is obvious that the control signal C₁ must be much lower than C₂₅₅. However, the storage of such a small value can be difficult due to the inertia of the system. Moreover, the error in the setting of this value (drift, etc.) will have much more impact on the final level than for the highest level. In the rest of the document, Cₜₕ is defined as the level that switches OFF the cell (could be Cₜₕ=0)

### 1.4. Basic AMOLED and Frame-Rate Adaptation (Multi-Scan Capability)

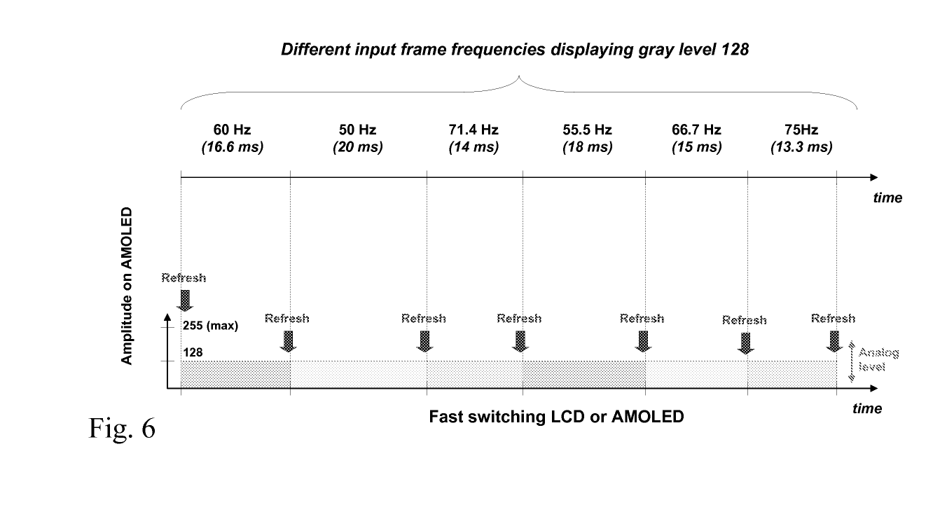

In classical driving, the addressing of the screen is locked to the input frame synchronization. This means, that each time a new frame is coming the addressing is started independently of the frame duration. FIG. 6 is an example showing the case of several input frequencies. This shows that if the source frequency is varying the addressing of the AMOLED will follow the input frequency. This change of frame duration will have absolutely no effect to the visual aspect of the image as shown with the example of gray level 128. This means that, if a grayscale is displayed on the screen at several input frequencies, the observatory cannot see any differences.

Since this concept is capable of supporting several input frequencies (according to the limitation of the driver speed), it is called a full multi-scan display.

1.5. Grayscale Rendition with Analog Sub-Field Concept

This concept has been deeply presented in the documents EP 1 743 315, EP 1 914 709 and EP 1964 092 and will be used here as background reference. The idea was to split an analog frame as it is used today in a multiple of analog sub-fields similar to that being used in a PDP (plasma display device). However, in PDP each sub-field can be only controlled in a digital way (fully ON or OFF) whereas in the present concept each sub-field will be an analog one (variable amplitude). The maximal bit depth of each sub-field is defined by the driver bit depth.

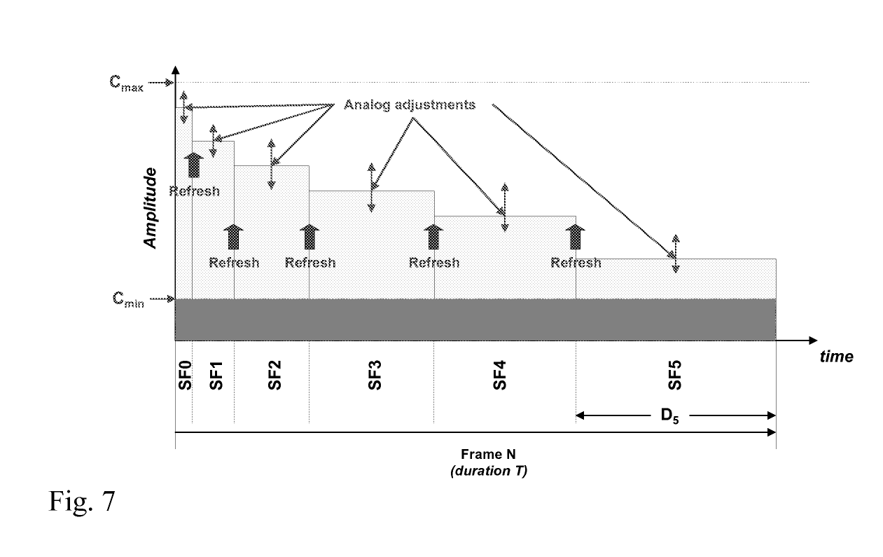

The number of sub-fields must be higher than two and its actual number will depend on the refreshing rate of the AMOLED (time required to update the value located in each pixel). The proposed concept is illustrated in FIG. 7.

This concept is based on a split of the original video frame in 6 sub-fields (SF0 to SF5). This number is only given as an example. There is a refresh at the beginning of each sub-field.

The data of each sub-field and the reference signals are used to generate a corresponding sub-field controlling signal. The amplitude of each sub-field controlling signal is decreasing step by step from SF0 to SF5 and may be adjusted by the reference signaling means 7 (compare FIG. 3) as indicated by double arrows in FIG. 7.

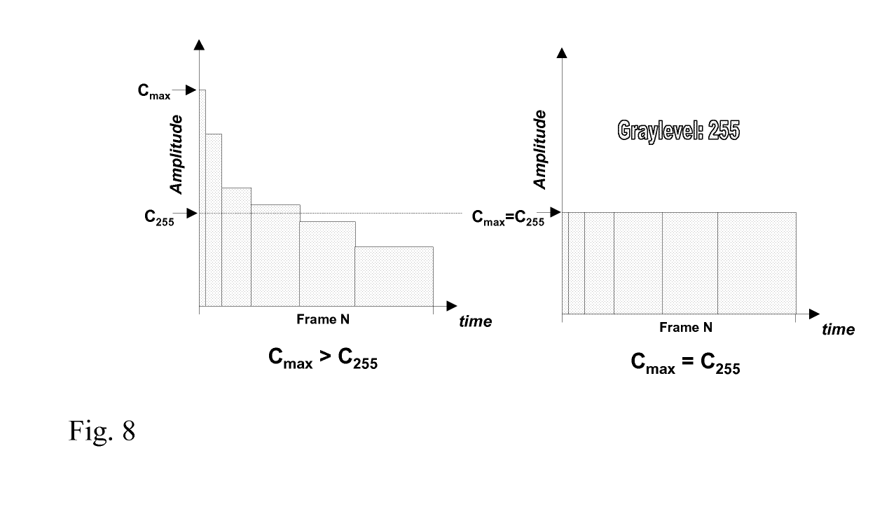

FIG. 8 illustrates the rendition of the white level for two possibilities of Cₘₐₓ as disclosed before (Cₘₐₓ=C₂₅₅ or Cₘₐₓ>C₂₅₅). On the left side of the picture, there is a light emission similar to that of CRT whereas on the right side the emission of white is similar to conventional methods. Concerning the low level rendition, both solutions are equivalent. In the same way the solutions are similar for the rendition of low level up to mid gray concerning the motion rendition. However, the concept described on the left side has the advantage of offering a better motion rendition for all levels whereas this advantage is limited to the range low-level up to mid-level for the other solution. Generally, the solution on the left side including the amplitude steps presents much more advantages. However, the maximal driving signals Cₘₐₓ used for some sub-fields is much higher and could have an impact on the display lifetime. This last parameter will define which concept should be used (a compromise between both is also realistic).

An other main advantage of the solution is that: the analog amplitude of a sub-frame (i.e. in a sub-field) is defined via a driver as presented on FIG. 3. If the driver is a Gbit driver for instance, each sub-frame has a 6-bit resolution on its analog amplitude. Finally, due to the split of the frames in many sub-fields, each one being on 6-bit basis, one can obtain much more bits due to the combination of sub-fields.

The further explanations, are limited to the left concept from FIG. 8, since this delivers the major advantages. In this concept, the duration of the several sub-frames (i.e. sub-fields) is fixed and therefore, if the input frame is changing, this mainly affects only the last sub-field that becomes longer, shorter or can even disappear. This phenomenon explains that if no specific solution is used, several input frame rates may have a disturbing effect. This will be explained with more details in the following pages.

2. Multi-Scan Solution with Analog Sub-Fields

### 2.1.Description Hypotheses

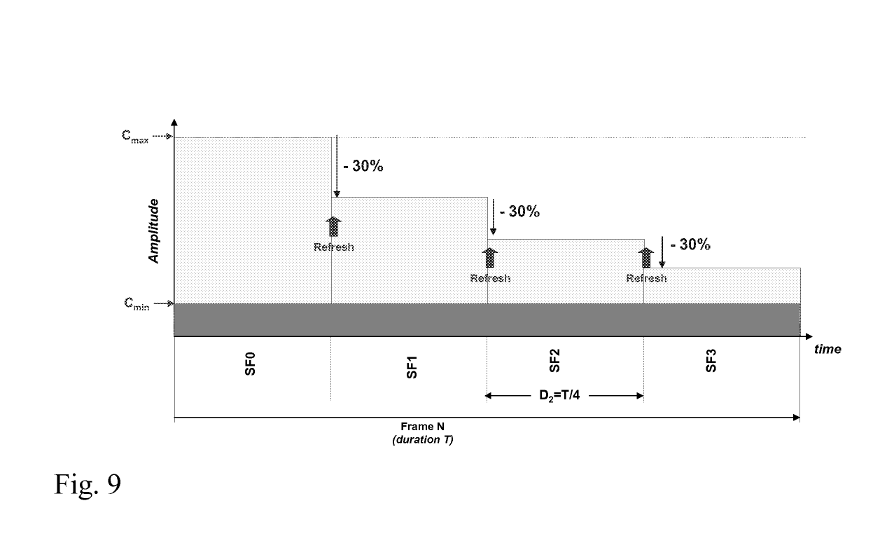

In order to simplify the exposition, the example of a frame built of four analog sub-frames in 60 Hz having equal length of 16.67/4=4.16 ms using a voltage driven system is taken. The voltage reference of each sub-field is chosen in order to have 30% luminance differences between consecutive sub-fields (the voltage differences are adjusted accordingly). This means, that each 4.16 ms, the voltage reference generator is updated according to the refresh of the Capacity for the given sub-field. All values and numbers given here are only examples! These hypotheses are illustrated in FIG. 9.

In real case, the number of sub-fields, their size and the amplitude differences is fully flexible and can be adjusted case by case depending on the application. In case of a current driven system, the same concept is used excepted that there is a linear relationship between applied current and luminance whereas in case of voltage driven system, the relation is a power of 2.

Therefore, in case of voltage driven the following relationship in terms of luminance is valid for one frame of the present example:

Out=¼×(X₀)²+¼×(0.7×X₁)²+¼×(0.49×X₂)²+¼×(0.343×X₃)²

where X₀, X₁, X₂ and X₃ are 8-bit information linked to the video values used for the four sub-fields SF₀, SF₁, SF₂ and SF₃.

In case of current driven, luminance of a frame is:

Out=¼×(X₀)+¼×(0.7×X₁)+¼(0.49×X₂)+¼×(0.343×X₃).

2.2. Increased Bit Depth from EP 1914 709

The following example shows that this system enables to dispose of more bits:
Maximum luminance: X₀=255, X₁=255, X₂=255 and X₃=255 which leads to an output value of

Out=¼×(255)²+¼×(0.7×255)²+¼×(0.49×255)²+¼×(0.343×255)²=30037.47 units.
Minimum luminance (without using the limit Cₘᵢₙ): X₀=0, X₁=0, X₂=0 and X₃=1 which leads to an output value of

Out=¼×(0)²+¼×(0.7×0)²+¼×(0.49×0)²+¼(0.343×1)²=0.03 units.

With a standard display without analog sub-field having the same maximum luminance, the lowest value would correspond to

$${( \frac{1}{N} )}^{2} \times 30037.47$$

where N represents the bit depth. So we have:
8-bit mode

$${( \frac{1}{255} )}^{2} \times 30037.47 = 0.46$$

9-bit mode

$${( \frac{1}{512} )}^{2} \times 30037.47 = 0.11$$

10-bit mode

$${( \frac{1}{1024} )}^{2} \times 30037.47 = 0.03$$

which can be achieved in the present example.

This shows that the use of the analog sub-fields while simply based on 8-bit drivers enables to generate increased bit-depth. However, the encoding must be done carefully.

Indeed, in normal situations (no analog sub-fields), half the input amplitude corresponds to fourth of the output amplitude since the relation input/output is following a quadratic curve in voltage driven mode. This has to be followed also while using an analog sub-field concept. In other words if the input value is half of the maximum available, the output must be fourth of that obtained with X₀=255, X₁=255, X₂=255 and X₃=255. This can not be achieved simply with X₀=128, X₁=128, X₂=128 and X₃=128.

### Indeed,

Out=¼×(128)²+¼×(0.7×128)²+¼×(0.49×128)²+¼×(0.343×128)²=7568.38

which is not 30037.47/4=7509.37! This is due to the fact that (a+b+c+d)²≠a²+b²+c²+d²!

Therefore a specific encoding algorithm must be used. In that case the input should be X₀=141, X₁=114, X₂=107 and X₃=94.

### Indeed,

Out=¼×(141)₂+¼×(0.7×114)²+¼×(0.49×107)²+¼×(0.343×94)²=7509.37

which is then exactly 30037.47/4. Such an optimization should be done for each possible input video value and stored inside a Look-Up table inside the chip. The number of inputs of this LUT will depend on the bit depth chosen. In case of 8-bit, the LUT will have 256 inputs and for each, four 8-bit outputs, one per sub-field. In case of 10-bit, the LUT will have 1024 inputs and for each, four 8-bit outputs, one per sub-field. This shows that an increased bit depth has also a cost in terms of memory needed.

For example a display capable of rendering 10-bit material shall be used.

In that case the output level should correspond to

$${( \frac{X}{1024} )}^{2} \times 30037.47$$

where X is a 10-bit value growing from 1 to 1024 by a step of 1. In table 3 one can find an example of coding that could be accepted to render 10-bit. This is only an example and further optimization can be done depending on the display behavior:

TABLE 3
10-bit encoding example for 60 Hz

| 10-bit analog display | | Analog sub-field encoding | | | | |
|---|---|---|---|---|---|---|
| Input | Awaited | | | | | Obtained |
| video | Energy | X0 | X1 | X2 | X3 | Energy |
| 1 | 0.03 | 0 | 0 | 0 | 1 | 0.03 |
| 2 | 0.11 | 0 | 1 | 0 | 0 | 0.12 |
| 3 | 0.26 | 1 | 0 | 0 | 0 | 0.25 |
| 4 | 0.46 | 1 | 1 | 1 | 1 | 0.46 |
| 5 | 0.72 | 1 | 1 | 2 | 2 | 0.73 |
| 6 | 1.03 | 2 | 0 | 0 | 1 | 1.03 |
| 7 | 1.40 | 2 | 1 | 2 | 1 | 1.39 |
| 8 | 1.83 | 2 | 2 | 2 | 2 | 1.85 |
| 9 | 2.32 | 3 | 0 | 1 | 0 | 2.31 |
| 10 | 2.86 | 3 | 2 | 1 | 1 | 2.83 |
| 11 | 3.47 | 3 | 3 | 1 | 1 | 3.44 |
| 12 | 4.13 | 4 | 1 | 0 | 0 | 4.12 |
| 13 | 4.84 | 4 | 2 | 2 | 2 | 4.85 |
| 14 | 5.61 | 4 | 3 | 2 | 3 | 5.61 |
| 15 | 6.45 | 5 | 1 | 1 | 1 | 6.46 |
| 16 | 7.33 | 5 | 3 | 0 | 0 | 7.35 |
| 17 | 8.28 | 5 | 4 | 1 | 1 | 8.30 |
| 18 | 9.28 | 6 | 1 | 1 | 2 | 9.30 |
| 19 | 10.34 | 6 | 3 | 2 | 0 | 10.34 |
| 20 | 11.46 | 6 | 4 | 2 | 3 | 11.46 |
| 21 | 12.63 | 7 | 1 | 2 | 1 | 12.64 |
| 22 | 13.86 | 7 | 3 | 2 | 3 | 13.86 |
| 23 | 15.15 | 7 | 4 | 4 | 0 | 15.17 |
| 24 | 16.50 | 7 | 5 | 4 | 3 | 16.54 |
| 25 | 17.90 | 7 | 6 | 4 | 3 | 17.89 |
| 26 | 19.36 | 7 | 7 | 4 | 2 | 19.33 |
| 27 | 20.88 | 7 | 7 | 6 | 4 | 20.88 |
| 28 | 22.46 | 8 | 7 | 2 | 3 | 22.51 |
| 29 | 24.09 | 8 | 8 | 2 | 0 | 24.08 |
| 30 | 25.78 | 8 | 8 | 5 | 4 | 25.81 |
| 31 | 27.53 | 8 | 8 | 7 | 5 | 27.52 |
| 32 | 29.33 | 9 | 7 | 7 | 2 | 29.31 |
| 33 | 31.20 | 9 | 8 | 7 | 2 | 31.15 |
| 34 | 33.11 | 9 | 9 | 6 | 5 | 33.07 |
| 35 | 35.09 | 10 | 7 | 8 | 3 | 35.11 |
| 36 | 37.13 | 10 | 8 | 8 | 4 | 37.15 |
| 37 | 39.22 | 10 | 9 | 8 | 4 | 39.23 |
| 38 | 41.36 | 10 | 10 | 8 | 3 | 41.36 |
| 39 | 43.57 | 11 | 9 | 7 | 4 | 43.58 |
| 40 | 45.83 | 11 | 9 | 9 | 5 | 45.77 |
| . . . | . . . | . . . | . . . | . . . | . . . | . . . |
| 512 | 7509.37 | 141 | 114 | 107 | 94 | 7509.37 |
| . . . | . . . | . . . | . . . | . . . | . . . | . . . |
| 1024 | 30037.47 | 255 | 255 | 255 | 255 | 30037.47 |

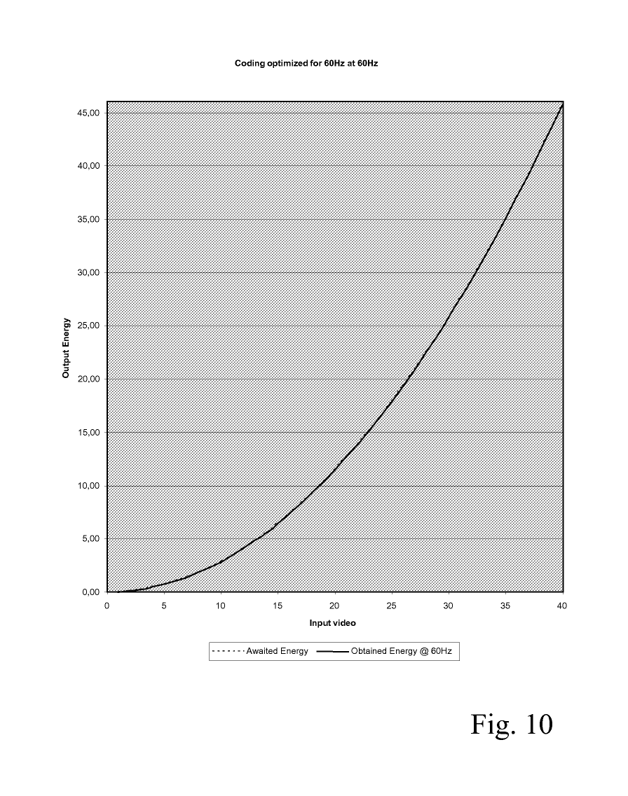

The difference between the awaited energy and the obtained energy is shown on FIG. 10.

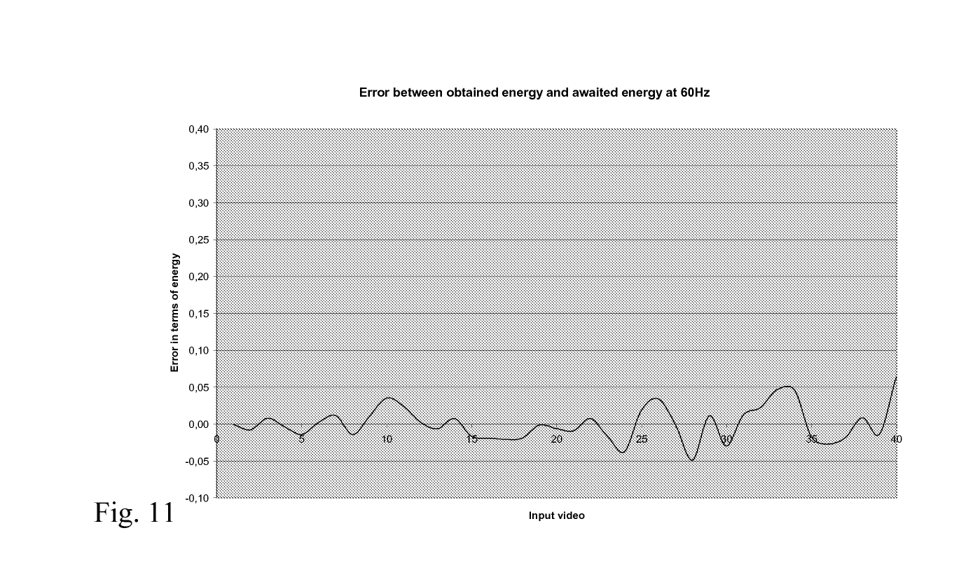

Table 3 and FIG. 10 show an example of a 10-bit encoding based on the above hypotheses: the energy obtained on the screen matches almost perfectly with the awaited energy delivering a smooth and quadratic gamma function. The variation between awaited energy and obtained energy is illustrated in FIG. 11.

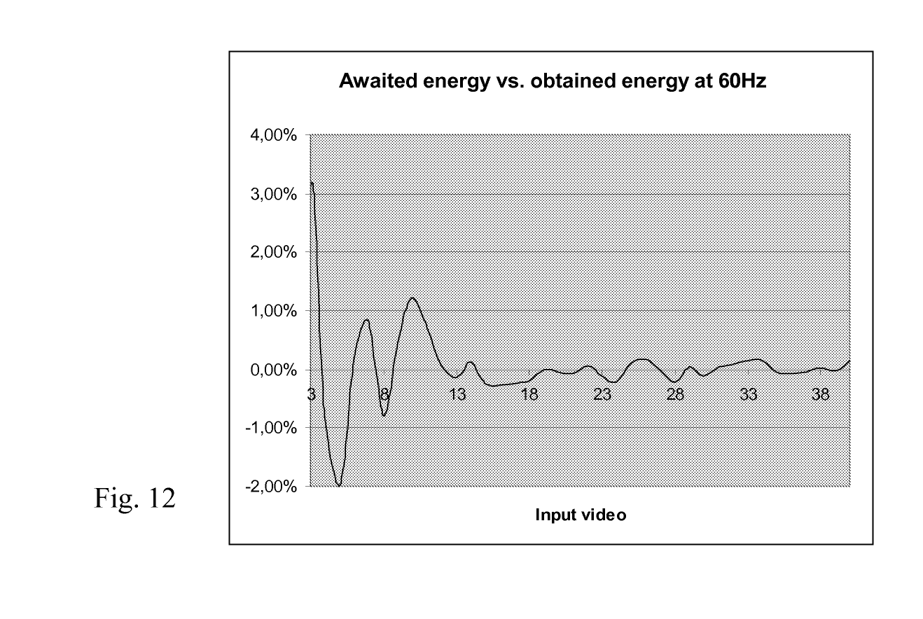

FIG. 12 shows, the same curve but in terms of percentage to awaited energy that is more relevant for the human eye due to its contrast sensitivity (relative and not absolute).

Several options can be used for the generation of the encoding table but usually following main points must be followed:
Minimize the error between the awaited energy and the displayed energy
Try to keep as much as possible the energy of Xₙ₊₁<Xₙ. This does not mean that the digital value must respect this rule but more the energy obtained at the end taking into account the voltage reference used for each sub-field.
X₀ must always grow with the input value.
Try to avoid inserting zeros between activated Xₙ
Try to reduce as much as possible the energy changes of each sub-field when the video value is changing

### 2.3. Case of Different Frame Rates

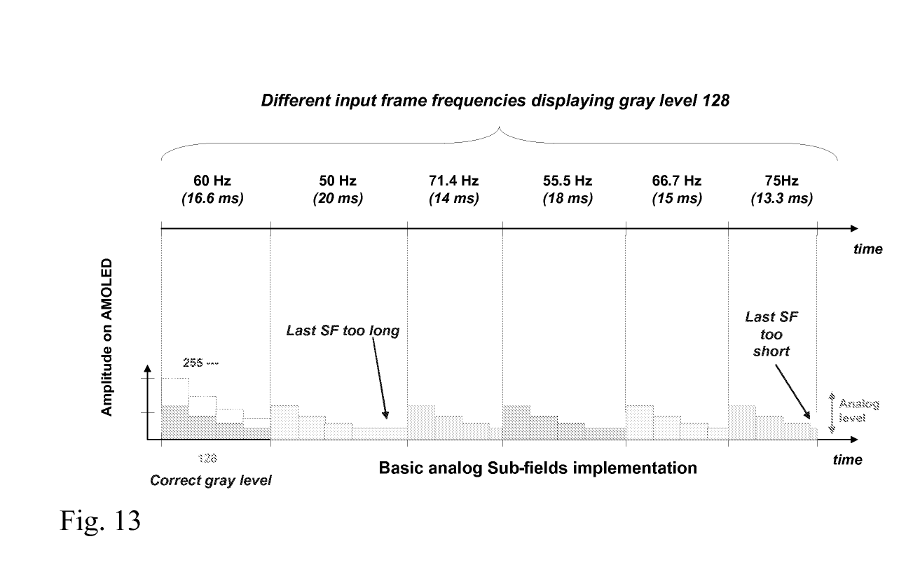

FIG. 13 shows the same situation as FIG. 6 applied to the hypotheses from FIG. 9 and related to the displaying of the gray level 128. Specifically FIG. 13 shows the problem of the analog SF implementation if the input frame frequency is different from the programmed one (60 Hz in this case) with sub-field duration based on 16.67 ms/4=4.16 ms.

It is obvious that a solution to overcome this problem is to develop several addressing schemes for different frequencies. For instance, five different modes like 50 Hz, 60 Hz, 75 Hz, 100 Hz and 120 Hz are supported. For each of them a different sub-field addressing and coding will be performed. However, this does not solve the problem of frequencies that are in-between like 66.7 Hz or 71.4 HZ from the example.

In the case of 66.7 Hz in a 60 Hz mode, the last sub-field should have the duration of 16.6/4=4.16 ms. However, the full frame duration is only 15 ms so that the last sub-field is 1.6 ms shorter (2.56 ms). In other words the last sub-field does not have the duration of one fourth of the frame duration but rather one sixth. Finally the energy obtained on the screen in this particular example is given by the formula below:

Out=¼×(X₀)²+¼×(0.7×X₁)²+¼×(0.49×X₂)²+⅙×(0.343×X₃)2

where X₀, X₁, X₂ and X₃ are 8-bit information linked to the video values used for the three sub-frames SF₀, SF₁, SF₂ and SF₃. When using this formula to update the encoding the results of 4 are obtained.

TABLE 4
10-bit encoding example for 60 Hz at 66.7 Hz

| 10-bit analog display | | Analog sub-field encoding | | | | |
|---|---|---|---|---|---|---|
| Input | Awaited | | | | | Obtained |
| video | Energy | X0 | X1 | X2 | X3 | Energy |
| 1 | 0.03 | 0 | 0 | 0 | 1 | 0.02 |
| 2 | 0.11 | 0 | 1 | 0 | 0 | 0.12 |
| 3 | 0.26 | 1 | 0 | 0 | 0 | 0.25 |
| 4 | 0.46 | 1 | 1 | 1 | 1 | 0.45 |
| 5 | 0.72 | 1 | 1 | 2 | 2 | 0.69 |
| 6 | 1.03 | 2 | 0 | 0 | 1 | 1.02 |
| 7 | 1.40 | 2 | 1 | 2 | 1 | 1.38 |
| 8 | 1.83 | 2 | 2 | 2 | 2 | 1.81 |
| 9 | 2.32 | 3 | 0 | 1 | 0 | 2.31 |
| 10 | 2.86 | 3 | 2 | 1 | 1 | 2.82 |
| 11 | 3.47 | 3 | 3 | 1 | 1 | 3.43 |
| 12 | 4.13 | 4 | 1 | 0 | 0 | 4.12 |
| 13 | 4.84 | 4 | 2 | 2 | 2 | 4.81 |
| 14 | 5.61 | 4 | 3 | 2 | 3 | 5.52 |
| 15 | 6.45 | 5 | 1 | 1 | 1 | 6.45 |
| 16 | 7.33 | 5 | 3 | 0 | 0 | 7.35 |
| 17 | 8.28 | 5 | 4 | 1 | 1 | 8.29 |
| 18 | 9.28 | 6 | 1 | 1 | 2 | 9.26 |
| 19 | 10.34 | 6 | 3 | 2 | 0 | 10.34 |
| 20 | 11.46 | 6 | 4 | 2 | 3 | 11.38 |
| 21 | 12.63 | 7 | 1 | 2 | 1 | 12.63 |
| 22 | 13.86 | 7 | 3 | 2 | 3 | 13.77 |
| 23 | 15.15 | 7 | 4 | 4 | 0 | 15.17 |
| 24 | 16.50 | 7 | 5 | 4 | 3 | 16.45 |
| 25 | 17.90 | 7 | 6 | 4 | 3 | 17.80 |
| 26 | 19.36 | 7 | 7 | 4 | 2 | 19.29 |
| 27 | 20.88 | 7 | 7 | 6 | 4 | 20.73 |
| 28 | 22.46 | 8 | 7 | 2 | 3 | 22.42 |
| 29 | 24.09 | 8 | 8 | 2 | 0 | 24.08 |
| 30 | 25.78 | 8 | 8 | 5 | 4 | 25.65 |
| 31 | 27.53 | 8 | 8 | 7 | 5 | 27.27 |
| 32 | 29.33 | 9 | 7 | 7 | 2 | 29.27 |
| 33 | 31.20 | 9 | 8 | 7 | 2 | 31.11 |
| 34 | 33.11 | 9 | 9 | 6 | 5 | 32.82 |
| 35 | 35.09 | 10 | 7 | 8 | 3 | 35.02 |
| 36 | 37.13 | 10 | 8 | 8 | 4 | 37.00 |
| 37 | 39.22 | 10 | 9 | 8 | 4 | 39.08 |
| 38 | 41.36 | 10 | 10 | 8 | 3 | 41.27 |
| 39 | 43.57 | 11 | 9 | 7 | 4 | 43.43 |
| 40 | 45.83 | 11 | 9 | 9 | 5 | 45.52 |
| . . . | . . . | . . . | . . . | . . . | . . . | . . . |
| 512 | 7509.37 | 141 | 114 | 107 | 94 | 7422.74 |
| . . . | . . . | . . . | . . . | . . . | . . . | . . . |
| 1024 | 30037.47 | 255 | 255 | 255 | 255 | 29399.96 |

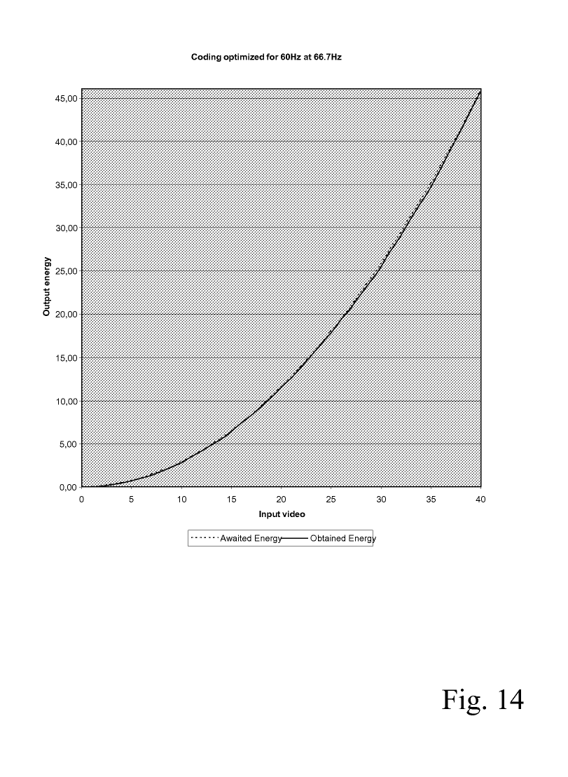

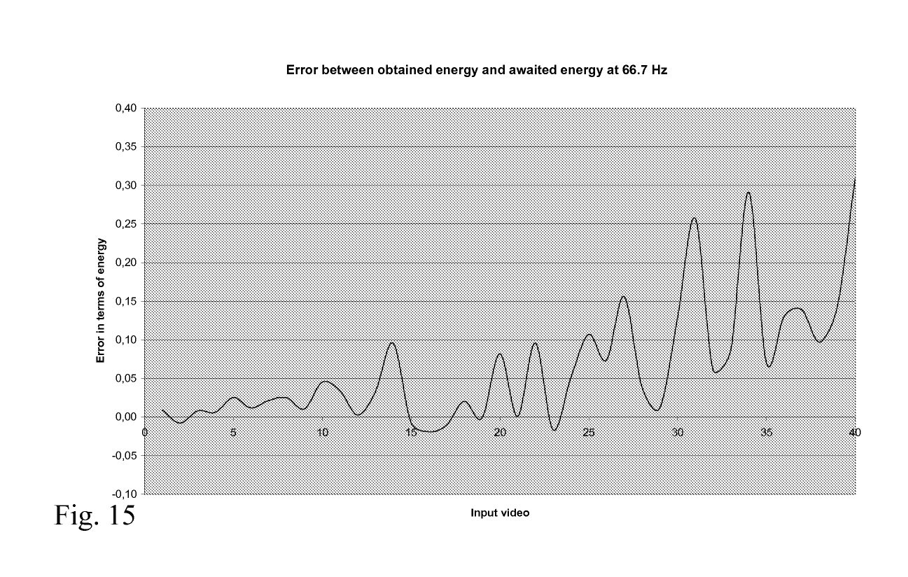

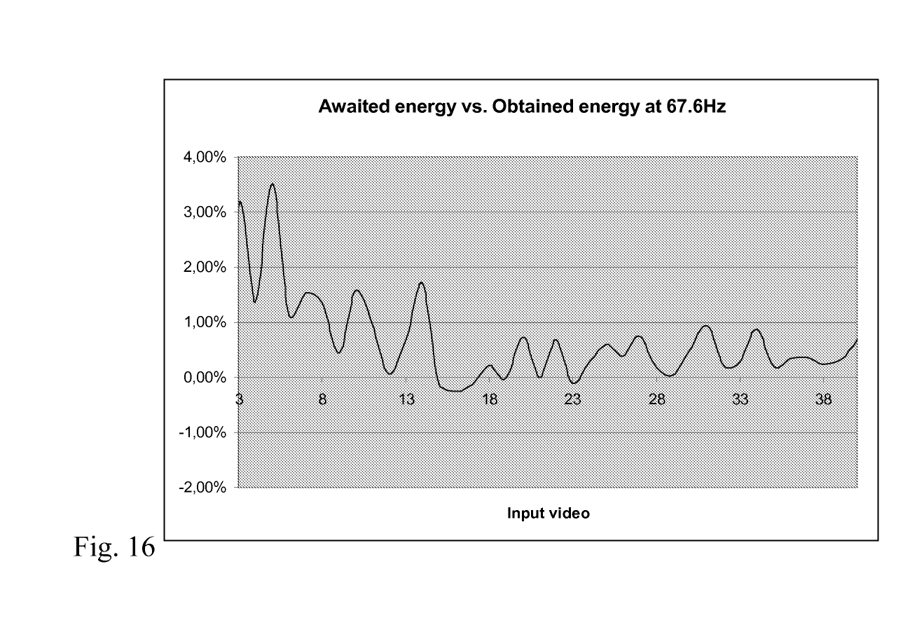

The difference between the awaited energy and the obtained energy can be seen in FIG. 14. This FIG. 14 and Table 4 relate to 10-bit encoding based on the mentioned hypotheses: the energy obtained on the screen shows variation regarding the awaited energy. Due to that, the grayscale curve is not stable and will evolve with the frame frequency. In other words, if there is a jitter in the frame frequency, the grayscale will show luminance variation following this jitter. The variation between awaited energy and obtained energy is illustrated in FIG. 15 absolutely and in FIG. 16 relatively.

FIG. 16 shows a stronger variation of the produced energy relative to the awaited energy in comparison to the FIG. 12.

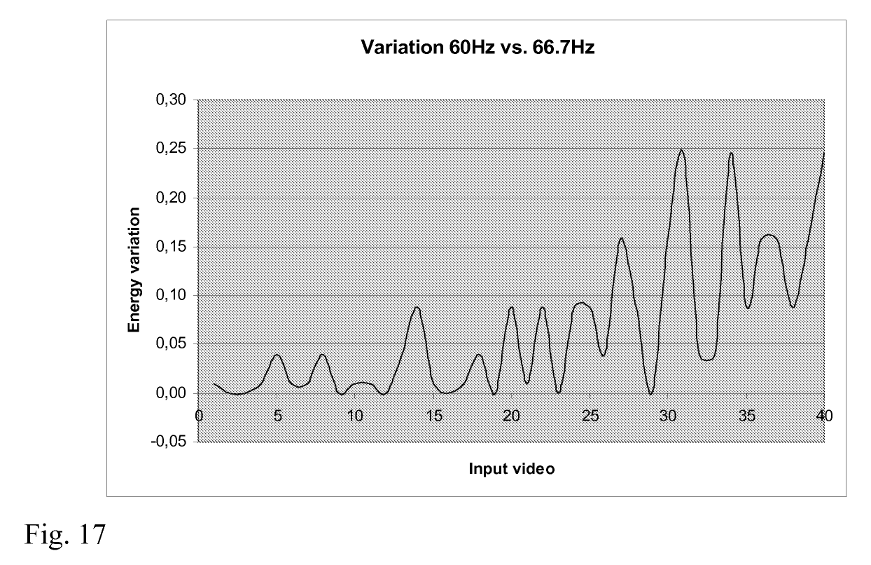

FIG. 17 shows the difference between the obtained energy according 60 Hz frame rate and the obtained energy according to 66.7 Hz for the same sub-field duration. It can be recognised that depending on the contribution of the last sub-field, the influence of the reduced frame duration is changing and therefore the variation between energy obtained at 60 Hz and the energy obtained at 66.7 Hz is oscillating, thus creating disturbances when the frame duration is not stable.

In order to avoid such problems, the analog sub-fields method should be adjusted to the real input frame duration. Several possibilities exist:
Adjusting the subfield coding: quite complex above all for voltage driven system.
Adjusting the sub-frame duration: the easiest solution but it can be limited by the electronic.
Adapting the voltage reference of the last subfields: can be used on top of the previous adjustment to continue when the sub-frame duration adjustment is limited.

The two last solutions will primarily be in the scope of this document.

### 2.4. Solution by Sub-Field Duration Adjusting

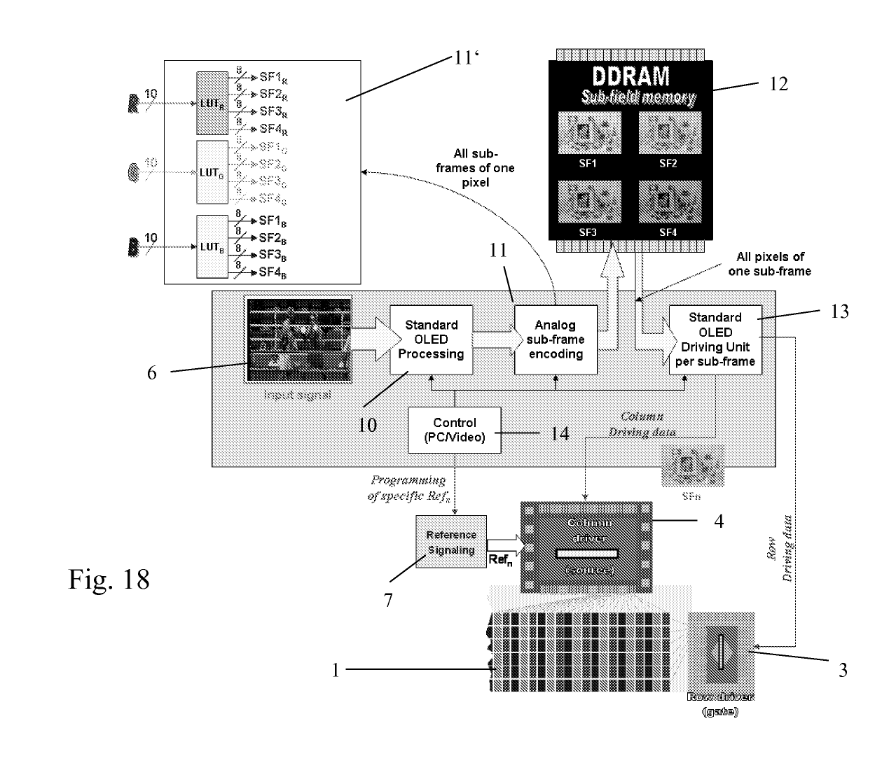

The implementation of the basic analog sub-field solution is described on FIG. 18. The input signal 6 is processed according to a standard (OLED) processing 10.

The resulting signal is transmitted to a unit for analog sub-frame (i.e. sub-field) encoding 11. As depicted in the enlarged box 11′, the incoming video information (RGB 30 bit) is forwarded to the encoding LUTs (one per color). The outputs of these LUTs are the several sub-fields bits: for each pixels all sub-fields data are available at the same time.

These sub-fields are stored at different positions of a sub-field memory 12 pixel by pixel and are read out of the memory 12 sub-field per sub-field. At one moment only one sub-field picture is read out of the memory 12, transferred to a standard (OLED) driving unit 13 and displayed on the screen 1 with the adjusted voltage references (reference signaling 7) corresponding to the sub-field level. This unit 13 controls the row drivers 3 and the column drivers 4. A central control unit 14 controls the standard processing unit 10, the sub-field encoding unit 11, the driving unit 13 and reference signaling unit 7.

This implementation shows that there is at least one frame delay between the displayed picture and the incoming picture due to the storage of the sub-fields in the frame memory 13. This delay will be very useful for the sub-field duration adjustments: the main idea is that the duration of each sub-field will be adjusted exactly to the full input frame duration.

For the example of displaying N sub-fields, this means:
On each new input frame F the input frame counter has to be reset with i_frame_count=0, and for each system clock until the next new input frame the counter is increased: i_frame_count++. At the end we have i_frame_duration(F)=i_frame_count, thus representing the input frame duration for frame F in system clock units.
In parallel to that, the previous frame duration i_frame_duration(F−1) is used to drive the sub-field output for frame F−1. On each new input frame F, the first sub-field SF1(F−1) is addressed and the sub-field counter i_SF_count=0 is reset, and for each system clock, we have i_SF_count+=N (the sub-field counter is increased by a factor related to the amount of subfields). Each time i_SF_count>=i_frame_duration(F−1), the next sub-field is addressed until the next input frame is coming and the sub-field counter is reset: i_SF_count=0.

In case of a frame duration of 15 ms (66.7 Hz) and a clock of 100 MHz, the frame duration will be i_frame_duration=1.499.250 clocks. For four sub-fields, the counter i_SF_count will increase four times faster than the clock, so that it will reach the value 1.499.250 only after 374812 clocks which represents a fourth of the input frame duration. By doing that the four sub-fields will have equal duration independently from the input frame frequency.

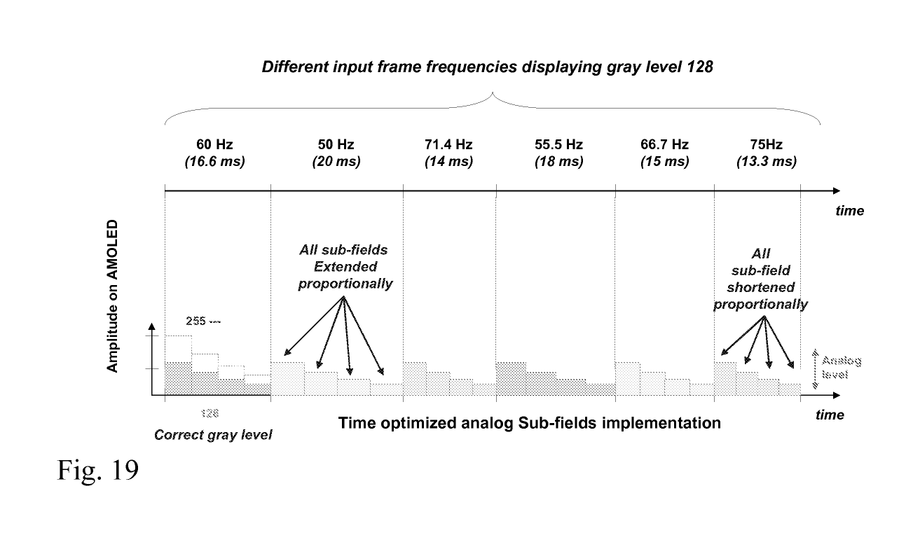

FIG. 19 illustrates this concept applied to the hypotheses from FIG. 9 and related to the displaying of the gray level 128. Due to the proportional change of the sub-field duration according the input frame frequency, there will be no luminance variation from frame to frame independently of their duration.

However, a new problem can occur mainly when the frame rate is getting shorter. The duration of the sub-fields is getting shorter also and may become too short for the given number of sub-fields.

In that case, the number i_frame_duration is compared with a threshold and if this duration is below the given threshold, an other mode with fewer sub-fields will be selected. For instance:
Modes below 55 Hz have 5 sub-fields (duration_threshold_1)
Modes between 55 Hz and 67 Hz have 4 sub-fields (duration_threshold_2)
Modes between 67 Hz and 90 Hz have 3 sub-fields (duration_threshold_3)
Modes above 90 Hz have 2 sub-fields (duration_threshold_4) This corresponds to the previous invention of the applicant under EP 1 964 092.

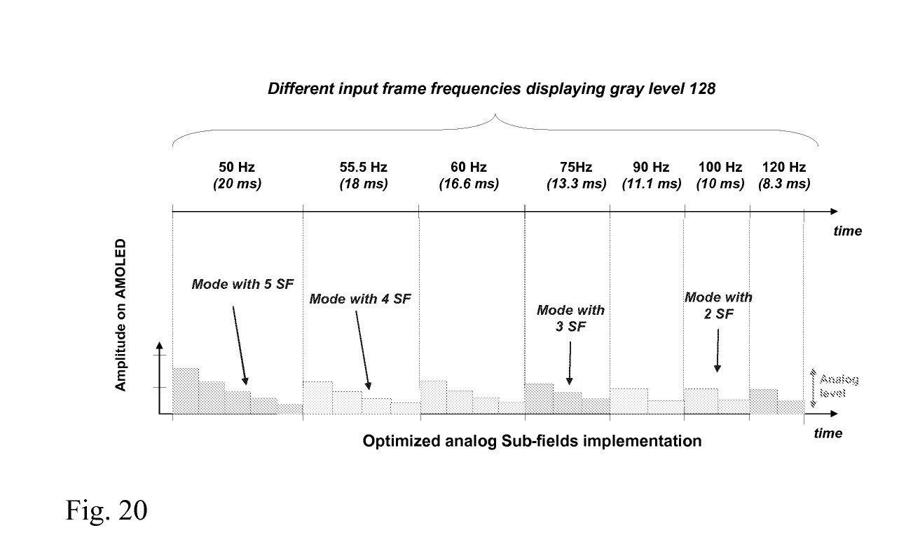

A corresponding example is illustrated on FIG. 20.

All sub-field modes are designed in such a way that the average luminance is constant between them. In that case, changing the number of sub-fields does not affect the image brightness. In order to achieve this, the voltage reference of all modes must be adjusted to take into account the luminance behavior of the selected addressing.

The LUT containing the sub-field coding and the voltage reference is computed one time and stored in a memory of the control board. It will be selectively activated based on the threshold defined above.

In order to compute optimally the references for the different numbers of sub-fields, there are two situations:
Current driven addressing: in order to keep the average luminance constant, the energetic surface must be kept constant. This means

$${\sum }_{k = 1}^{k = n} ( \frac{1}{n} \times {I}_{max} ( {SF}_{n} ) ) = En$$

where En represents a constant luminance energy that should be displayed and Iₘₐₓ(SFₙ) the maximum current of the sub-field n.
Voltage driven addressing: in order to keep the average luminance constant, the energetic surface must be kept constant, taking into account the fact that the relation voltage to luminance is a power of 2. This means

$${\sum }_{k = 1}^{k = n} ( \frac{1}{n} \times {( {V}_{max} ( {SF}_{n} ) )}^{2} ) = En$$

where En represents a constant luminance energy that should be displayed and Vₘₐₓ(SFₙ) the maximum voltage of the sub-field n.

The LUTs are computed one time and stored in a memory of the control board.

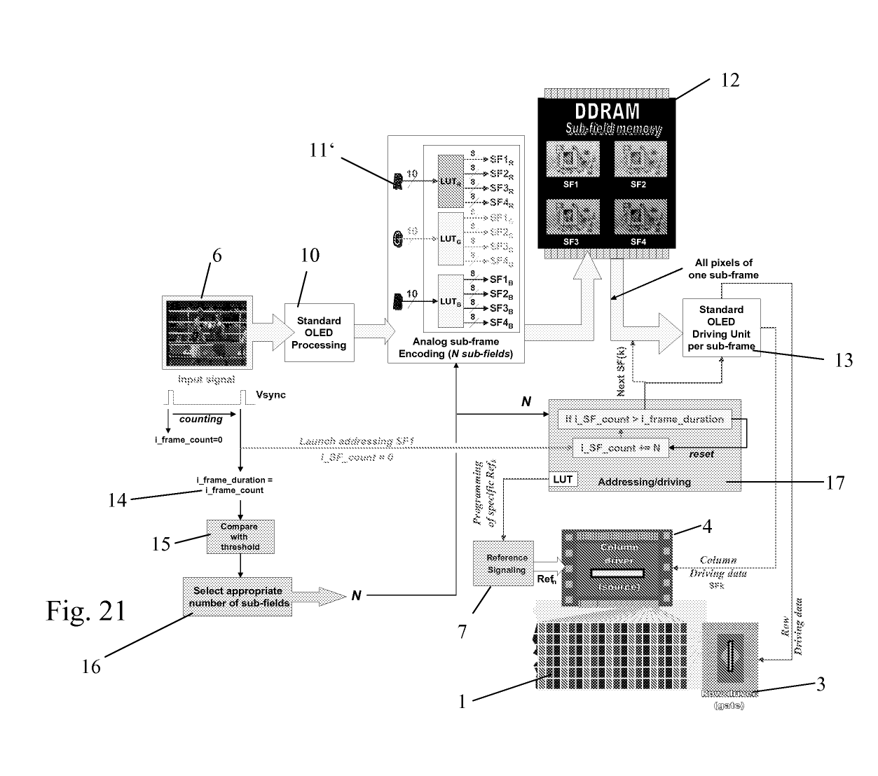

FIG. 21 shows a representation of an implementation based on the implementation of FIG. 18. The incoming image (input signal 6) is represented by a vertical synchronization signal Vsync. On each new Vsync, a counter i_frame_count is reset. This counter is incremented until the next Vsync and its value is stored in i_frame_duration (reference sign 14), thus representing the duration in number of clocks between two Vsync.

The value i_frame_duration is compared with several thresholds (reference sign 15) (e.g. duration_threshold_m from the above example) to determine (reference sign 16) how many sub-fields should be used: N

This value N is used to select all Look-Up-Tables (coding addressing, driving references . . . ) in blocks 11′ and 17.

On the next Vsync, the first sub-field is addressed and SF1 is required from the memory. At the same time the counter i_SF_count is increased by the value N until it reaches the current i_frame_duration. This requires the addressing of the next sub-field SF2, its addressing and the counter i_SF_count is reset. This loop will last until the next Vsync, where the cycle will start again.

The inventive teaching is applicable to all displays using the sample & hold principle (AMOLED, LCD . . . ).

1-7. (canceled)

8. Method for displaying a picture on a multi-scan hold type display screen including the steps of
providing an input signal including a sequence of plural frames, each corresponding to a single picture,
temporally dividing each frame having a frame duration into analog sub-fields,
providing a set of reference signals for specifying the analog signal amplitudes of sub-field controlling signals, each corresponding to one of said analog subfields,
controlling a display element of the display screen on the basis of said sub-field controlling signals, and
wherein
the amplitude of a sub-field controlling signal corresponding to the last sub-field of each frame is automatically adapted to the frame duration of the frame.

9. Method according to claim 8, wherein the amplitude of sub-field controlling signals decreases stepwise from the beginning of a frame to its end.

10. Method according to claim 8, wherein the output energy resulting from a frame is a pregiven function of the corresponding level of the input signal, and the analog sub-fields are coded accordingly.

11. Multi-scan hold type display device for displaying a picture including
a display screen having a plurality of display elements,
input means for providing an input signal including a sequence of plural frames, each corresponding to a single picture,
encoding means for temporally dividing each frame having a frame duration into analog sub-fields,
controlling means for providing a set of reference signals for specifying the analog signal amplitudes of sub-field controlling signals, each corresponding to one of said analog sub-fields, and for controlling a display element of the display screen on the basis of said sub-field controlling signals,
comprising
adaption means for automatically adapting the amplitude of a sub-field controlling signal corresponding to the last analog sub-field of each frame to the frame duration of the frame.

12. Display device according to claim 11 wherein the amplitude of sub-field controlling signals decreases stepwise from the beginning of a frame to its end.

13. Display device according to claim 11 wherein the output energy resulting from a frame is a pregiven function of the corresponding level of the input signal and the encoding means is capable of encoding the analog sub-fields accordingly.

14. Display device according to claim 11 wherein the display screen is an OLED or AMOLED display.
